(19) United States
(12) Patent Application Publication
(10) Pub. No.: US 2011/0140449 A1
(43) Pub. Date: Jun. 16, 2011

(54) WIND POWER DEVICE

(75) Inventor: Hsueh Cheng Huang, Hamilton (NZ)

(73) Assignee: OPEN MINDER GROUP LIMITED, Tortola (VG)

(21) Appl. No.: 12/967,598

(22) Filed: Dec. 14, 2010

(30) Foreign Application Priority Data
Dec. 16, 2009 (TW) 098143058

(51) Int. Cl. F03D 3/04

(52) U.S. Cl. 290/55

(57) ABSTRACT

A wind power device is provide that includes a first carrier with a first active layer disposed thereon, a second carrier with a second active layer disposed thereon, at least a wind-receiving member connected to the first and second active layers and at least a power unit. The wind-receiving member takes in wind energy for activating the first and second active layers to drive the power unit to generate power. The wind power device advantageously provides ease in assembly and maintenance and is suitable to environments with variable wind directions and capable of being flexibly adjusted to adapt to varying wind speeds and thus achieve optimal power generating efficiency.

### BACKGROUND OF THE INVENTION

1. Field of the Invention

The present invention relates generally to wind power devices, and more particularly, to a wind power device operable in different wind directions and at different wind speeds.

2. Description of Related Art

Our daily life depends on electric power. There are various modes of power generation, such as thermal, hydro, wind, solar, or nuclear power generation.

However, thermal power generation pollutes the environment, and thermal sources, such as coal, crude oil, and natural gas, have a limited reserve. Hydroelectric power generation is seldom stable in terms of the level of power generated. Solar power generation incurs high operation costs. Nuclear power generation causes a concern about radiation safety. Therefore, as a clean and renewable energy, wind power generation has become increasingly popular.

Most of conventional wind power devices can be divided into horizontal-axis type and vertical-axis type. A horizontal-axis wind power device consists of a plurality of blades and a tower, wherein the blades are rotated by natural wind so as to generate electric power. But such a horizontal-axis wind power device has its drawbacks. Generally, the tower of the horizontal-axis wind power device must be at least 60 meters in height. The body of the tower must be robust enough to ensure the stability of the tower. The base of the tower needs to be built on high-strength reinforced concrete foundations. The blades must be of a large size for providing sufficient wind receiving area. Therefore, such a horizontal-axis wind power device incurs high land costs and assembly costs. Also, the bulky blades are heavy and friction-stricken to the detriment of the performance of the horizontal-axis wind power device. In addition, direction and speed of natural wind are variable, but the horizontal-axis wind power device is not adjustable in response to changes in wind directions and speeds. For example, the blades stop rotating at a low wind speed but has to undergo idle rotation at a high wind speed so as to protect the horizontal-axis wind power device against damage otherwise caused by rotation of the blades at high wind speed, thus resulting in a waste of wind resources.

A vertical-axis wind power device comprises a plurality of single-layer sails vertically disposed on a central column so as to rotate around the central column. Such a vertical-axis wind power device is generally designed for providing low to medium power generating capacity. In addition, mechanical bearings are usually used in the vertical-axis wind power device for facilitating the rotation mechanism thereof, which however are easy to damage and thereby increases maintenance costs.

Therefore, it is imperative to provide a wind power device so as to overcome the above drawbacks of the prior art.

### SUMMARY OF THE INVENTION

In view of the above drawbacks of the prior art, the present invention provides a wind power device that facilitates assembly and maintenance and can be used in environments with variable wind directions and can be flexibly adjusted to adapt to variable wind speeds, thereby efficiently utilizing wind power resources.

According to the present invention, the wind power device comprises: a first carrier having a ring track structure; a first active layer freely movable relative to the first carrier thereunder; a second carrier having a ring track structure and disposed at an interval from the first carrier; a second active layer freely movable relative to the second carrier thereunder; at least a wind-receiving member connected to the first and second active layers for taking in wind energy so as to cause the first and second active layers to move on the first and second carriers, respectively; and at least a power unit, the driving shaft of which has a driven wheel in contact with the first active layer or the second active layer and rotatable through motion of the active layer. Therefore, when the wind-receiving member causes the first and second active layers to move on the first and second carriers, respectively, the driven wheel in contact with the first active layer or the second active layer is driven to rotate by the first active layer or the second active layer so as to generate electrical energy.

In a preferred embodiment, the wind power device further comprises at least a support member connected to the first and second active layers, and the support member is extendable and/or elastic. Further, the wind power device comprises at least a wind-collecting apparatus comprised of a plurality of wind-collecting members and disposed at the periphery of the wind power device for guiding, concentrating, diverting or blocking wind power. Preferably, the wind-collecting apparatus is arranged in a triangle, a rectangle, a pentagon, or any other n-sided polygon, where n is an odd integer greater than 5.

In another preferred embodiment, the driven wheel of the power unit is a gear, and racks are formed on the surface of the first active layer and/or second active layer in contact with the gear so as to engage with the gear. Preferably, the racks are not at a uniform height. As such, the gear of the power unit is provided with different torques based on the engaging degree of the racks and gear so as to rotate at different speeds.

In another preferred embodiment, the first carrier and the second carrier each comprise a plurality of carrier units connected in series and locked with each other, and the carrier units can be made of plastic or polymer. Further, each of the first active layer and the second active layer can comprise a plurality of active units connected in series and locked with each other, and the active units can be made of metal or metal compound.

Further, a plurality of wind-receiving members can be connected with the first active layer and the second active layer, wherein the wind-receiving members can be spaced from each other and arranged in a ring shape corresponding to the ring track structure of the first and second carriers.

The wind power device according to the present invention facilitates assembly and maintenance and can be used in environments with variable wind directions and can be flexibly adjusted to adapt to varying wind speeds, thereby efficiently utilizing wind power resources to generate electrical energy.

### BRIEF DESCRIPTION OF DRAWINGS

FIG. 1 is a perspective schematic view of a wind power device according to an embodiment of the present invention;

FIG. 1A is a partially exploded view of the wind power device of the present invention;

FIG. 1B is a partially sectional view of the wind power device of the present invention;

FIG. 2 is a perspective schematic view of a wind power device according to another embodiment of the present invention;

FIG. 3 is a top view of the wind power device according to another embodiment of the present invention; and

FIG. 3A is a partially side view of the wind power device of the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

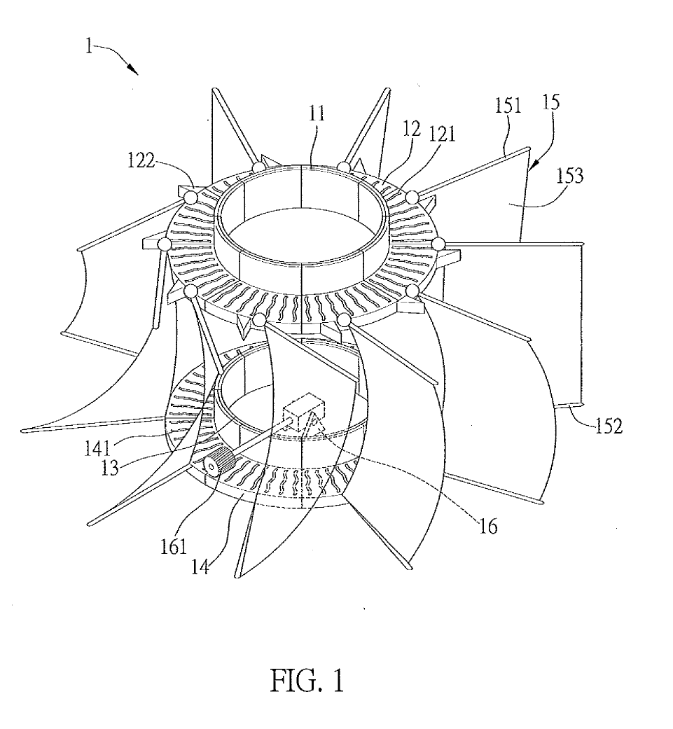

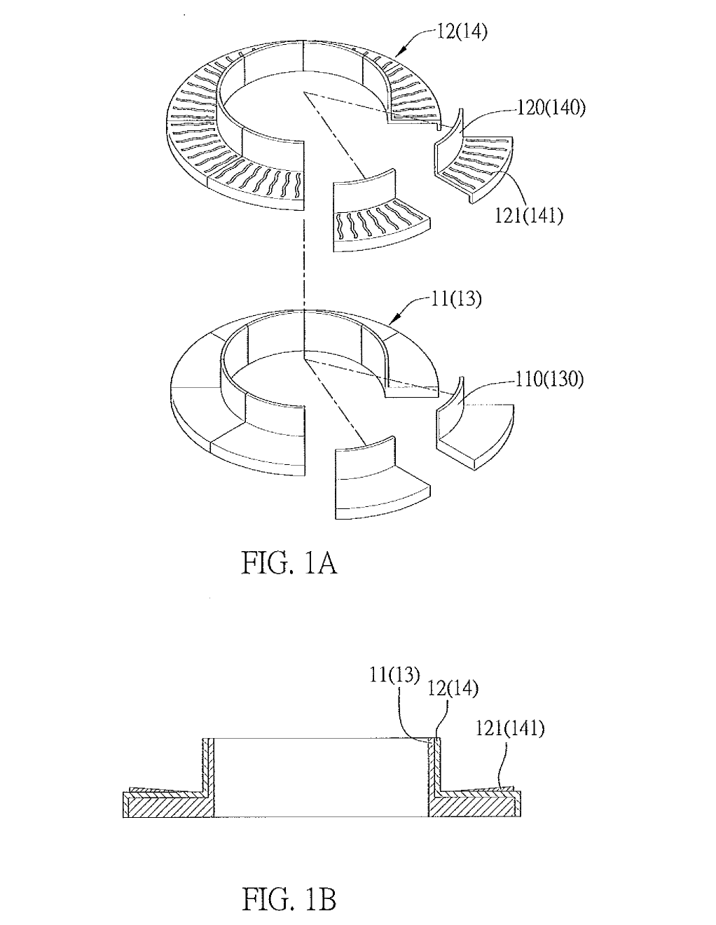

Referring to FIG. 1, there is shown a perspective schematic view of the structure of a wind power device according to an embodiment of the present invention. Referring to FIG. 1, the wind power device 1 comprises: a first carrier 11 with a first active layer 12 disposed thereon, a second carrier 13 with a second active layer 14 disposed thereon, a plurality of wind-receiving members 15 connected to the first active layer 12 and the second active layer 14, and a power unit 16. FIG. 1A is an exploded view showing the first carrier 11, the second carrier 13, the first active layer 12, and the second active layer 14.

The first carrier 11 and the second carrier 13 have a ring track structure (of a circular shape, an elliptical shape or a rectangular shape, for example). The first carrier 11 and the second carrier 13 each comprise a plurality of carrier units 110(130) connected in series and locked with each other. The carrier units 110(130) can be made of plastic (such as polyethylene, polypropylene, polyvinyl chloride) or plastic polymer, and have high hardness.

For example, the carrier units 110 (130) mainly comprise a high molecule weight synthetic resin with an additive such as a plasticizer, a stabilizer, a flame retardant, a lubricant, a coloring agent and the like, which is then processed to obtain a material structure with adequate plasticity, flexibility and rigidity.

In the present embodiment, the first carrier 11 and the second carrier 13 are disposed at an interval from each other.

The first active layer 12 and the second active layer 14 have a ring track structure (of a circular shape, an elliptical shape or a rectangular shape, for example) corresponding to the ring track structure of the first carrier 11 and the second carrier 13. The first active layer 12 and the second active layer 14 are freely movable relative to the first and second carriers 11, 13, respectively. Further, the first active layer 12 and/or the second active layer 14 comprise a plurality of active units 120 (140) connected in series and locked with each other. The active units 120 (140) are made of metal (such as iron, copper, aluminum), a metal compound, or an alloy (such as steel).

The carrier units 110 (130) or the active units 120 (140) can be connected in series or locked with each other by a plurality of coupling devices, such as screws, chains, engaging rings or the like. The aforesaid means of series-connection and coupling are well known in the art, and thus detailed description thereof is omitted herein for brevity. In addition, the contact surfaces between the first carrier 11 and the first active layer 12 and the contact surfaces between the second carrier 13 and the second active layer 14 are smooth surfaces with low friction. For example, the first active layer 12 and the second active layer 14 are made of a metal material, and the first carrier 11 and the second carrier 13 are made of a plastic material. Friction arising from the metallic contact surfaces and plastic contact surfaces are low; hence, the first active layer 12 and the second active layer 14 can smoothly move (rotate) on the first carrier 11 and the second carrier 13, respectively, thereby preventing mechanical bearings from malfunction or damage which is otherwise common in the prior art.

Further, since the first carrier 11 and the second carrier 13 comprise the plurality of carrier units 110 (130) connected in series and/or locked with each other, they can be easily replaced in the case of wear and tear or attrition. Similarly, since the first active layer 12 and the second active layer 14 comprise the plurality of active units 120 (140) connected in series and locked with each other, they can be easily replaced in the case of wear and tear or attrition.

The wind-receiving members 15 are connected to the first active layer 12 and the second active layer 14 for taking in wind energy so as to drive the first active layer 12 and the second active layer 14 to move (rotate) on the first carrier 11 and the second carrier 13, respectively. In addition, the wind-receiving members 15 can be spaced from each other and arranged in a ring shape.

Each of the wind-receiving members 15 is of a sheet shape, a paddle shape, or a wing shape. In the present embodiment, the wind-receiving members 15 each comprise a first mast 151 connected to the first active layer 12, a second mast 152 connected to the second active layer 14, and a sail 153 connected between the first mast 151 and the second mast 152. The shape, size, and quantity of the wind-receiving members 15 are subject to changes as needed.

The driving shaft of the power unit 16 has a driven wheel 161 capable of being driven to rotate through motion of the first active layer 12 and/or the second active layer 14. When the wind-receiving members 15 drive the first active layer 12 and the second active layer 14 to perform motion relative to the first carrier member 11 and the second carrier member 13, the driven wheel 161 in contact with the first active layer 12 or the second active layer 14 is driven by the first active layer 12 or the second active layer 14 to rotate, thereby generating electrical energy. The shape, quantity, or position of the power unit 16 can be flexibly changed according to wind speed and/or wind amount of the environment where the wind power device 1 is located. For example, the power device 1 installed in a windy environment usually comprises a plurality of said power units 16 operating concurrently so as to achieve the optimal power generating efficiency and thereby prevent a waste of wind power resources.

In the present embodiment, the driven wheel 161 is a gear, and the first active layer 12 and/or the second active layer 14 have/has contact surfaces through which the first active layer 12 and/or the second active layer 14 come/comes into contact with the driven wheel 161 of the power unit 16. The contact surfaces of the first active layer 12 and/or the second active layer 14 are provided with a plurality of racks 121 (141) for engaging with the driven wheel 161. Further, the racks 121 (141) are independent of or integrally formed with the first active layer 12 and/or the second active layer 14. The racks 121 (141) are parallel or radial as needed.

Referring to FIG. 1B, there is shown a sectional view showing the structure of the first carrier 11, the first active layer 12 and the racks 121 as well as the second carrier 13, the second active layer 14 and the racks 141. As shown in FIG. 1B, the racks 121 (141) are not at a uniform height. The position of the driven wheel 161 and the racks 121 (141) can be adjusted according to variation of wind power and speed or the quantity of the power unit 16, thereby providing different torques to the power unit 16. The shape, quantity, and/or spacing of the racks 121 (141) are subject to changes as needed.

In a preferred embodiment, the first masts 151 can be connected to the first active layer 12 through a brake such as a hydraulic lever, and the first active layer 12 further has at least a position limiting member 122. The brake is used for adjusting the range of movement of the first masts 151, thereby changing the wind receiving angle of the sails 153 connected between the first masts 151 and the second masts 152. The position limiting member 122 is used for limiting the range of movement of the first masts 151 relative to the first active layer 12.

In practice, in order to efficiently utilize wind power resources, a plurality of wind power devices 1 can be stacked together such that one of the wind power devices 1 has a rotating direction (clockwise or anti-clockwise) different from the superior or inferior one of the wind power devices 1 through the combination of the position limiting member 122 and the brake. Through the combination of the position limiting member 122 and the brake, the wind receiving angle of the sails 153 at a wind receiving side can be adjusted such that the sails 153 achieve the optimal wind receiving area (maximum wind receiving area). On the other hand, the wind receiving angle of the sails 153 at a non-wind-receiving side can be adjusted so as to release wind power. Of course, wind power can be transmitted to upper or lower ones of the wind power devices 1 so as to optimally utilize wind power resources.

In another preferred embodiment, the wind-receiving members 15 can be movably connected to the first active layer 12 and the second active layer 14 through brakes and rotary joints. Further, position limiting members can be disposed on the first active layer 12 and the second active layer 14 for limiting the range of movement of the wind-receiving members 15 on the first active layer 12 and the second active layer 14.

In another preferred embodiment, the wind-receiving members 15 are fixed to the first active layer 12 and movably connected to the second active layer 14. Position limiting members are disposed on the second active layer 14 for limiting the range of movement of the wind-receiving members 15 on the second active layer 14.

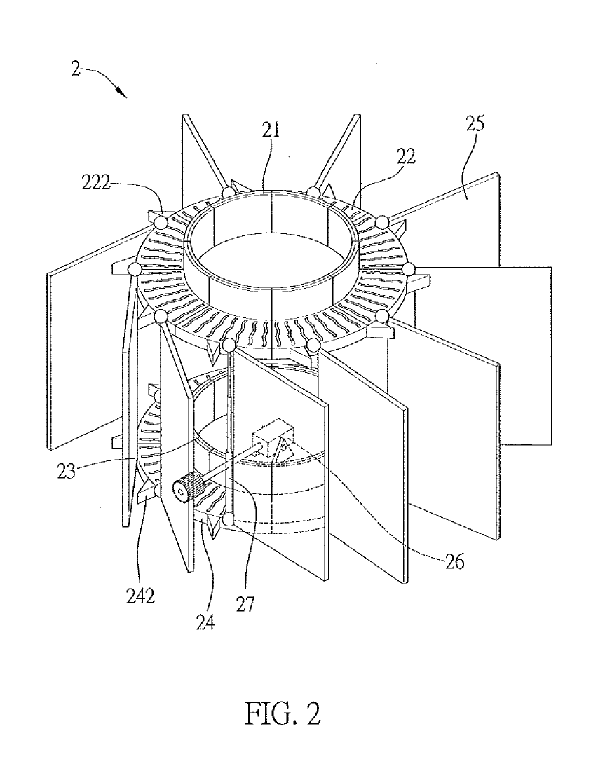

Referring to FIG. 2, there is shown a perspective schematic view of the structure of a wind power device 2 according to another embodiment of the present invention. The wind power device 2 comprises: a first carrier 21, a first active layer 22, a second carrier 23, a second active layer 24, a plurality of wind-receiving members 15 and a power unit 26. Unlike the wind power device 1, the wind power device 2 further comprises at least a support member 27, and the wind-receiving members 25 have sheet-shaped, paddle-shaped or wing-shaped bodies with a certain degree of hardness. The wind-receiving members 25 is movably connected to the first active layer 22 and the second active layer 24.

The support member 27 is extendable and/or elastic, which is connected to the first active layer 22 and the second active layer 24 for supporting the first active layer 22 and the second active layer 24. Furthermore, wind is seldom uniformly applied to the wind-receiving members 25, and thus there is a significant difference between the motion speeds of the first active layer 22 and the second active layer 24, which can cause damage of the wind-receiving members 25. But in the present embodiment, the support member 27 can simultaneously drive the first active layer 22 and the second active layer 24 to perform motion relative to the first carrier 21 and the second carrier 23, respectively, thereby preventing damage of the wind-receiving members 25. The length, width and quantity of the support member 27 can be changed according to environment. Further, since the wind-receiving members 25 are movably connected to the first active layer 22 and the second active layer 24, position limiting members 222, 242 are disposed on the first active layer 22 and the second active layer 24, respectively, so as to support the wind-receiving members 25 and limit the range of movement of the wind-receiving members 25, thereby making the wind power device applicable to environments with variable wind directions.

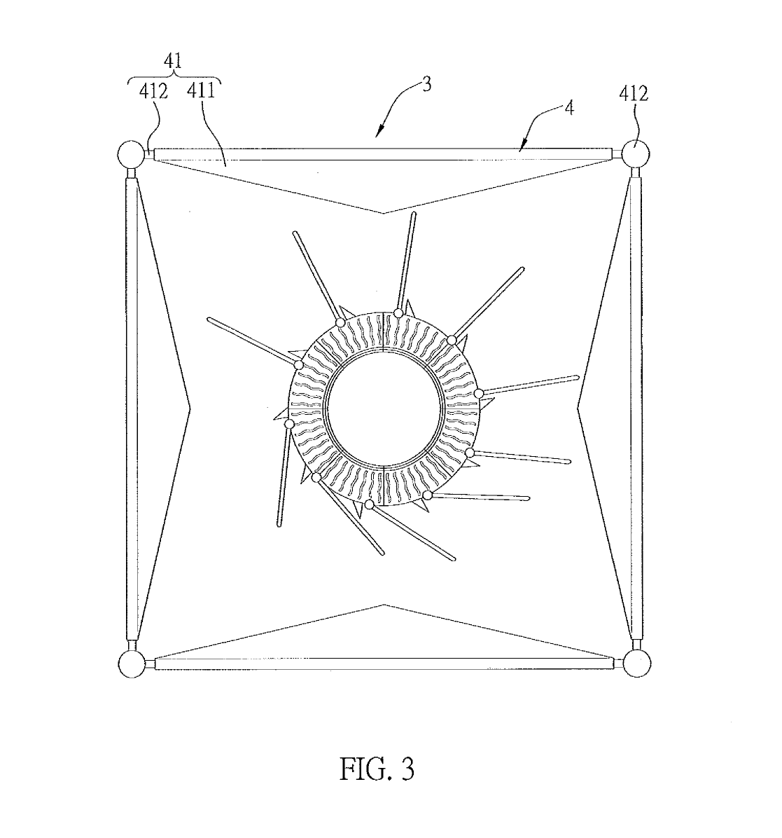

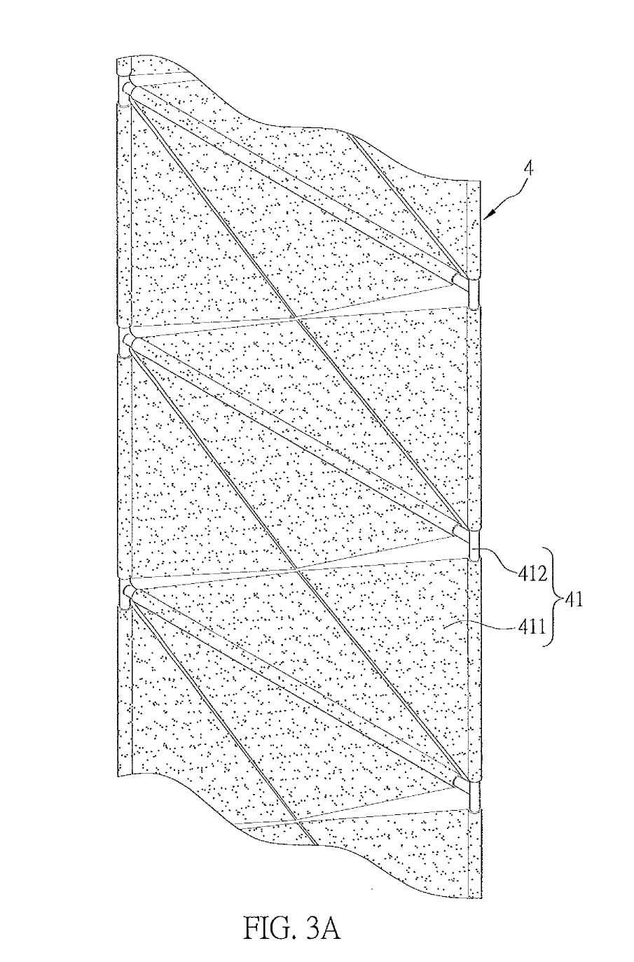

Referring to FIG. 3, there is shown a top view of a wind power device 3 according to another embodiment of the present invention. The elements, structure, configuration of the wind power device 3 are substantially the same as those of the wind power devices 1, 2 but differ therefrom in that the wind power device 3 further comprises at least a wind-collecting apparatus 4.

Referring to FIG. 3, the wind-collecting apparatus 4 is disposed at the periphery of the wind power device 3 for guiding, concentrating, diverting or blocking wind. The wind-collecting apparatus 4 comprises a plurality of wind-collecting members 41. The wind-collecting members 41 can be arranged in a triangle, a rectangle, a pentagon, or any n-sided polygon (where n is an odd integer greater than 5), and configured to surround the wind power device 3 so as to guide wind to the inside of the wind power device 3 and obtain the optimal wind incident angle. As shown in the drawing for an illustrative purpose, the wind-collecting members 41 are arranged in a rectangle.

The wind-collecting members 41 each comprise a plurality of wind shields 411 and brackets 412, as shown in FIG. 3A. The wind shields 411 can swing back and forth and move up and down relative to the brackets 412 through some control devices (not shown). The shape and quantity of the wind shields 411 and the brackets 412 are subject to changes as needed. The wind-collecting members 41 of the wind-collecting apparatus 4 are arranged in a triangle, a rectangle, a pentagon, or any n-sided polygon, where n is an odd integer greater than 5. The wind-collecting apparatus 4 is disposed at the periphery of the wind power device 3 so as to guide winds to blow at the optimal incident angle. In practice, a plurality of wind-collecting apparatuses 4 can be stacked and connected together according to various wind directions, speeds, environments, power device height, building height and user demands so as to efficiently utilize wind power resources.

The wind power device according to the present invention comprises a first carrier, a first active layer, a second carrier, a second active layer, at least a wind-receiving member and at least a power unit. The first active layer and the second active layer are disposed on the first carrier and the second carrier, respectively. The wind-receiving member is used to cause the first active layer and the second active layer to move, thereby driving the power unit to generate electrical energy. Compared with the prior art, the wind power device of the present invention is suitable to various environments, is easy to assemble and maintenance, and can be flexibly adjusted to adapt to varying wind directions and speeds, thereby efficiently utilizing wind power resources to generate electrical energy.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

What is claimed is:

1. A wind power device, comprising:
a first carrier configured to be ring-shaped and track-like;
a first active layer freely movable relative to the first carrier positioned thereunder;
a second carrier configured to be ring-shaped and track-like, spaced apart from the first carrier, and corresponding in position to the first carrier;
a second active layer freely movable relative to the second carrier positioned thereunder;
at least a wind-receiving member connected to the first and second active layers for taking in wind energy for driving the first and second active layers to perform motion relative to the first and second carriers, respectively; and
at least a power unit having a driving shaft provided with a driven wheel rotatable through motion of the first and second active layers to allow the first or second active layer come in contact with the driven wheel to drive rotation of the driven wheel for generating electric power whenever the wind-receiving member drives the first and second active layers to perform motion relative to the first and second carriers, respectively.

2. The device of claim 1, further comprising at least a support member connected to the first and second active layers.

3. The device of claim 2, wherein the support member is extendable and/or elastic.

4. The device of claim 1, further comprising at least a wind-collecting apparatus disposed at a periphery of the device for guiding, concentrating, diverting or blocking wind.

5. The device of claim 4, wherein the wind-collecting apparatus comprises a plurality of wind-collecting members arranged in a triangle, a rectangle, a pentagon or any n-sided polygon, where n is an odd integer greater than 5.

6. The device of claim 1, wherein the driven wheel is a gear, and racks configured for engagement with the gear are formed on contact surfaces of the first active layer and/or second active layer in contact with the gear.

7. The device of claim 6, wherein the racks are not at a uniform height.

8. The device of claim 1, wherein the first carrier and the second carrier each comprise a plurality of carrier units connected in series and locked with each other.

9. The device of claim 8, wherein the carrier units are made of plastic or plastic polymer.

10. The device of claim 1, wherein the first active layer and/or second active layer comprise a plurality of active units connected in series and locked with each other.

11. The device of claim 10, wherein the active units are made of metal or metal compound.

12. The device of claim 1, wherein the wind-receiving member has a sheet-shaped body or a paddle-shaped body, which is movably connected to the first and second active layers.

13. The device of claim 1, further comprising at least a position limiting member disposed on the first active layer or the second active layer for limiting a range of movement of the wind-receiving member.

14. The device of claim 1, wherein the wind-receiving member comprises a first mast connected to the first active layer, a second mast connected to the second active layer, and a sail connected between the first mast and the second mast.

15. The device of claim 14, wherein the first mast and the second mast are movably connected or fixed to the first active layer and the second active layer, respectively.

16. The device of claim 15, further comprising at least a position limiting member disposed on the first active layer or the second active layer so as to limit a range of movement of the first mast or the second mast whenever the first mast or the second mast is movably connected to the first active layer or the second active layer.

17. The device of claim 14, wherein the first mast or the second mast is connected to the first active layer or the second active layer through a brake.

18. The device of claim 17, wherein a range of motion of the first mast or the second mast is adjusted through the brake so as to change wind receiving angle of the sail connected between the first mast and the second mast.

19. The device of claim 1, wherein the first carrier, the second carrier, the first active layer and the second active layer form a ring structure.

20. The device of claim 19, wherein a plurality of the wind-receiving members are connected with the first active layer and the second active layer, spaced apart from each other by a specific distance, and arranged in a circular shape.
